(19) United States
(12) Patent Application Publication
(10) Pub. No.: US 2015/0144491 A1
(43) Pub. Date: May 28, 2015

(54) SOLID-LIQUID SEPARATION METHOD

(71) Applicant: MEIDENSHA CORPORATION, Tokyo (JP)

(72) Inventor: Hiroshi Noguchi, Setagaya-ku (JP)

(73) Assignee: MEIDENSHA CORPORATION, Tokyo (JP)

(21) Appl. No.: 14/407,245

(22) PCT Filed: Jun. 10, 2013
(86) PCT No.: PCT/JP2013/065997

§ 371 Date: Dec. 11, 2014

(30) Foreign Application Priority Data
Jun. 15, 2012 (JP) 2012-135344

(51) Int. Cl. B01D 57/02

(52) U.S. Cl. CPC B01D 57/02
USPC 204/548

(57) ABSTRACT

To separate solid matter contained in a liquid phase in a membrane separation tank 2, a pH of the liquid phase is adjusted to make a surface charge of the solid matter electrically homopolar with a surface charge of a ceramic flat membrane 3 to separate the solid matter from the liquid phase. Alternatively, by adding, to the liquid phase, a charge adjusting agent having a surface charge electrically homopolar to a surface charge of the ceramic flat membrane 3 and electrically heteropolar to a surface charge of the solid matter, the surface of the solid matter is charged to have an apparent surface charge electrically homopolar to the surface charge of the inorganic membrane 3.

### TECHNICAL FIELD

The present invention relates to technique for separating solid matter in the form of dispersed particles in a liquid phase by using an inorganic membrane, and more specifically to technique for preventing fouling (membrane occlusion) in the inorganic membrane.

### BACKGROUND ART

Membrane treatment is used for separating suspended solids, colloidal particles, and even specified molecules by selecting a pore diameter of a separation membrane.

In dependence on the pore diameter or pore size, separation membranes are classified into microfiltration membrane (MF membrane), ultrafiltration membrane (UF membrane), nanofiltration membrane (NF membrane), reverse osmosis membrane (RO membrane), etc.

In these membrane processes, the driving force for moving matter is a pressure difference, and filtration is achieved by pressurization or decompression. Objects to be separated in membrane treatment are minute particles of about 0.05˜10 μm such as suspended material and bacteria in water in the case of MF membrane, and polymeric substance having a molecular weight of about 1000˜300000 such as protein, enzyme, emulsion, bacteria, virus in the case of UF membrane, for example.

Two types of membrane filtration are cross flow filtration and dead end filtration (Non-patent documents 1 and 2).

The cross flow filtration is a method of filtration using the flow of liquid to be treated, along a membrane surface. This filtration system is arranged to restrain accumulation of turbid components on the membrane surface during filtration, so that the cross flow filtration is advantageous in resistance to clogging, as compared to the dead end filtration. However, the cross flow filtration is disadvantageous in the need for power for circulating the liquid to be treated.

The dead end filtration is a method of filtering the whole amount of the liquid to be treated. Since the power for circulating the liquid to be treated is not required unlike the cross flow filtration, the dead end filtration enables energy-saving filtering operation. However, the flow of the liquid to be treated is perpendicular to the membrane, and therefore, deposition or sediment is formed inevitably on the membrane surface. Moreover, it is not possible to perform a filtering operation restraining accumulation of the turbid components on the membrane surface as the cross flow filtration. Accordingly, it is necessary to stop the filtering operation periodically and to remove the sediment on the membrane by physical clearing and chemical cleaning.

Fouling is accumulation of attached substance or accretion on the membrane and clogging of permeation paths with passage of time in the filtering process. Periodical cleaning (operation to remove the adhered matter) is required.

As the method for restraining fouling of filtration membrane, in a dead end filtration or full flow filtration system, there is known a membrane treatment method of restraining membrane fouling by forming a coating layer containing inorganic particles on a filtering membrane surface, and thereafter performing membrane filtration (Patent Document 1).

The above-mentioned coating layer includes at least two layers having different properties. A coating lower layer contacting with the filtering membrane is a layer of inorganic particles formed by filtering a coating solution containing the above-mentioned inorganic particles. A coating upper layer on the other side is a layer of flocs formed by filtering the coating solution containing flocs obtained by flocculation of inorganic particles by addition of a flocculation agent or flocculant to the coating solution. With this construction, this membrane treatment system is designed to restrain membrane fouling, reduce the number of times for chemical cleaning, and to reduce the cost of equipment and maintenance.

In the production of bitumen from oil sands, a large quantity of water is used for the need for warm water and vapor at the time of mining, and therefore, there is produced a huge amount of drainage water produced and affected by the mining process (oil sands produced water, hereinafter referred to as OSPW), containing oil and clay. Oil sands are sands in a sand layer saturated with “bitumen”, viscous heavy oil. Part of the drainage water is recycled. The remaining part of the drainage water is stored in a reservoir, and held for several months to separate sands, heavy metal and oil from water by spontaneous sedimentation, to reuse clear supernatant water.

The inorganic membrane of ceramic is robust, advantageous in physical and chemical durability, and hydrophilic. Therefore, research is currently in progress, as to technique to process OSPW with the inorganic membrane, and to separate solid matter in the form of dispersed particles in drainage water efficiently.

In one method for restraining membrane fouling in the dead end filtration, a coating layer containing inorganic particles is formed on the filtering membrane surface before membrane filtration of water to be treated.

However, there is need for performing back washing frequently because, by continuation of filtration in the dead end filtration system to filter the total amount, the concentration of substance to be separated increases in the vicinity of the filtering membrane surface and the permeability is decreased inevitably by accumulation of the substance on the membrane surface. Therefore, the operation management is complicated by the need for repetition of an operation of stopping the membrane filtration and an operation of forming the coating layer.

As the measure for restraining membrane fouling in filtration process, there are still no effective means for solution though the restraint for restraining accumulation and deposition of fouling matter on the membrane is applicable to both the cross flow filtration and the dead end filtration.

### PRIOR ART LITERATURE

### Non-patent Documents

Non-patent Document 1: “Osui Haisui Shori no Chishiki to Gijutsu (Knowledge and technique for treatment of sewage and drainage)” by Miyoshi Yasuhiko, Ohmsha, first edition, August 2002, pp. 114˜118.

Non-patent Document 2: “Seramikku Hiramaku wo mochiita Jnkansiki Shouka Datutitugata Makubunri Kassei Odeihou, Gijutsusiryou (Circulating Nitrification Denitrification type Membrane separation Activated sludge Method, Technical Information)” Japan Institute of Waste water engineering and technology, March, 2012.

Non-Patent Document 3: “ζ Deni Sokuteihou no Teiri to Ouyourei (Theorem and Application Examples of ζ potential Measurement)”, by TAKADA Junn, TOAGOUSEI Group Research Annual Report, TREND2011, Number 14, January 2011, pp. 27˜30.

### Patent Document

Patent Document 1: JP2004-130197A

### SUMMARY OF THE INVENTION

Therefore, according to the present invention, to separate solid matter contained in a liquid phase, a pH of the liquid phase is adjusted to make a surface charge of the solid matter electrically homopolar with a surface charge of an inorganic membrane to separate the solid matter from the liquid phase.

Moreover, according to another aspect of the. present invention, to separate solid matter contained in a liquid phase, a surface of the solid matter is charged to have an apparent surface charge electrically homopolar to a surface charge of an inorganic membrane, by adding, to the liquid phase, a charge adjusting agent having a surface charge electrical homopolar to a surface charge of the inorganic membrane for separating the solid matter from the liquid phase and electrically heteropolar to a surface charge of the solid matter.

Thus, at the time of separating the solid matter contained in the liquid phase, the surface charge of the inorganic membrane and the apparent surface charge of the solid matter are electrically homopolar to each other, and the electric attractive force therebetween is weakened. Therefore, in the separation of the solid matter in the liquid phase, it is possible to restrain or reduce fouling of the inorganic membrane by the solid matter.

### BRIEF DESCRIPTION OF THE DRAWINGS

FIG. 1 is a schematic view showing the construction of membrane separation apparatus according to an embodiment of the present invention.

FIG. 2 is a schematic vertical sectional view showing schematically the construction of a ceramic flat membrane or flat sheet ceramic membrane.

FIG. 3 is a view for illustrating change of the charge state of a metallic oxide surface.

FIG. 4 is a characteristic view showing a relationship of a ζ potential of α-alumina with respect to pH.

FIG. 5 is a characteristic view showing isoelectric points and ζ potentials of various inorganic compounds.

FIG. 6 is a schematic view showing the construction of membrane separation apparatus according to another embodiment of the present invention.

### MODE(S) FOR CARRYING OUT THE INVENTION

Following is explanation on embodiment(s) of the present invention with reference to the drawings.

As a result of concentrated study and examination to achieve a separation membrane which per se has a function to prevent adhesion of matter to be separated by filtration, on the basis of following phenomena (1)˜(5), the present invention has been completed.

(1) An inorganic membrane made of an inorganic substance including, as a main component, metallic oxide is charged in a water solution or aqueous solution so that the surface charge of the metallic oxide is positive when the pH is lower than an isoelectric point, and negative when the pH is higher than the isoelectric point.

(2) In the case of an inorganic membrane including α-alumina as main component, for example, the isoelectric point of α-alumina normally lies near 9. Therefore, the surface charge of this inorganic membrane is positive in a neutral water solution, and the surface charge of this inorganic membrane is negative in a water solution or aqueous solution of pH 10.

(3) When solids in a water or aqueous solution are dispersed particles of metallic oxide, the surfaces of the solids are charged positively when the pH is lower than the isoelectric point of the metallic oxide, and charged negatively when the pH is higher than the isoelectric point.

(4) In the pH condition in which the surface charge of the inorganic membrane is opposite in polarity or heteropolar to the surface charge of the solids in a water solution, there is produced, between the inorganic membrane and the solids, electrical attraction or affinity. Consequently, the solids are liable to adhere to the membrane surface, and the membrane is susceptible to clogging.

(5) When the surface charges of the solid matter and inorganic membrane are opposite in polarity or heteropolar to each other, even in the case of addition of a charge adjusting or controlling agent having a surface charge opposite in polarity or heteropolar to the surface charge of the solid matter, it is possible to restrain clogging of the membrane by holding the electric polarity of the surface charge of the solid matter unchanged, and making the surface charge of the inorganic membrane equal in polarity or homopolar to the surface charge of the solid matter by adjustment of the pH.

Thus, in the method of separating solid matter in the form of dispersed particles in a water solution or aqueous solution with an inorganic membrane, to prevent adhesion of the solid matter to the inorganic membrane, the inventor has found that adjustment of the surface charge of the inorganic membrane or the solid matter is effective and reached the present invention.

According to one embodiment of the present invention, in separation of solid matter contained in a liquid phase, the pH of the liquid phase is adjusted to charge the solid matter to have the surface charge electrically homopolar to the surface change of an inorganic membrane for separating the solid matter from the liquid phase.

According to another embodiment of the present invention, in separation of solid matter contained in a liquid phase, the surface of the solid matter is charged to have an apparent surface charge electrically homopolar to the surface charge of an inorganic membrane for separating the solid matter from the liquid phase, by adding, to the liquid phase, a charge adjusting or controlling agent having a surface charge electrically homopolar to the surface charge of the inorganic membrane and electrically heteropolar to the surface charge of the solid matter.

According to still another embodiment of the present invention, in separation of solid matter contained in a liquid phase, in the case in which the surface charge of the solid matter is electrically heteropolar to the surface charge of an inorganic membrane for separating the solid matter from the liquid phase, the pH of the liquid phase is adjusted to charge the surface of a charge adjusting or controlling agent having a surface charge electrically heteropolar to the surface charge of the solid matter so that the surface charge of solid matter formed by addition of the charge adjusting agent becomes electrically homopolar to the surface change of another solid matter formed by addition of the charge adjusting agent.

For example, the inorganic membrane is an inorganic membrane containing, as main component, a metal oxide which is, as an example, aluminum oxide such as α-alumina. However, the material of inorganic membrane is not limited to metal oxide. The inorganic membrane may be an inorganic membrane containing, as main component, at least one of metal oxide and metallic hydroxide.

Specifically, as metal oxide and metal hydroxide, the main component of the inorganic membrane may include at least one compound of aluminum oxide, aluminum hydroxide, titanium oxide, titanium hydroxide, zirconium oxide, zirconium hydroxide, zinc oxide, zinc hydroxide, silicon oxide and silicon hydroxide.

The inorganic membrane may be preferably an inorganic membrane including, as main component, at least one of metallic oxides and metallic hydroxides having amphoteric property. However, the inorganic membrane is not limited to membranes of these substances, and the inorganic membrane may be a membrane of inorganic substance having a specified or predetermined surface charge in a liquid phase.

As the form of the inorganic membrane, one example of the inorganic membrane is a ceramic flat membrane or flat sheet membrane 3 of an external pressure type solid-liquid separation type, as shown in FIG. 2. The ceramic flat membrane 3 has a dual layer structure which includes a substrate or base material 31 of ceramic plate having a good water permeability, and membrane(s) 32 of ceramic having finer texture and covering the outside surface(s) of substrate 31 and which functions as filtration membrane in the whole outside surface(s). The pore size of membranes or films 32 to be selected is smaller than general bacteria (1˜2 μm). The substrate 31 includes therein water collecting passages or tubes 33 in the form of tubular voids or cavities. As to the mode of water conduction, feed water or water to be treated is introduced from the outside of each membrane 32 into the collecting passages 33, as shown by arrows. All the collecting passages 33 are connected to a collector tube equipped with an opening allowing filtered water or filtrate to be taken out. The opening is arranged to apply a negative pressure as a secondary side or permeate side to take the filtered water to the outside, and to suck the filtered water for filtration.

Moreover, as the form of the inorganic membrane, it is possible to use a single membrane as the ceramic flat membrane 3 shown in FIG. 2, or a plurality of membrane elements combined and united as a membrane module.

As the solid-liquid separating system, besides the above-mentioned external pressure type, it is possible to employ a filtration system of an internal pressure type to supply a feed water or water to be treated, into the inside of the membrane (the inner side of hollow fiber or tube), and cause the treatment water to flow to the outside (the outer side of the hollow fiber or tube).

The material of the inorganic membrane need not be a single substance such as ceramic. The material of the inorganic membrane may be a mixture of two or more substances. Moreover, the structure of the inorganic membrane is not limited to the dual layer structure. The structure of the inorganic membrane may be a single layer structure or a multilayer structure. In the case of the membrane structure including a plurality of layers, only for an outside surface layer, a membrane of material having a predetermined isoelectric point can be disposed in the outside surface layer.

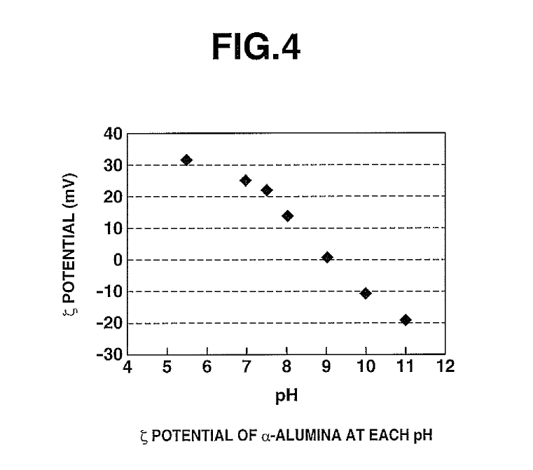

In the case in which the main component of the inorganic membrane is metallic oxide, the surfaces of particles include hydroxyl groups, an acid-base reaction is generated in dependence on pH, and consequently the charge is changed to minus, neutral and plus (Non-patent document 3). FIG. 3 schematically illustrates the reaction. The hydroxyl group is protonated and charged positively when the pH is low, and the hydroxyl group is deprotonated and charged negatively when the pH is high. Therefore, when the pH is varied continuously, the positive and negative charges become equal and hence the particle seems to be not charged at a certain pH value which is called an isoelectric point. For example, according to a relationship of the potential of α-alumina at each pH value shown in FIG. 4, the isoelectric point of α-alumina is approximately equal to 9 (Non-Patent Document 3). Therefore, in the case of the inorganic membrane including, as main component, metallic oxide, the surface charge in water is influenced by pH. The potential represents an electric potential that exists across an interface between solid and liquid, and expresses the charge state of colloid particle or solid surface in a solution liquid as surface potential (surface charge). When the potential becomes close to zero, the repulsive force among minute particles becomes weaker, resulting in aggregation or flocculation.

In the case of the inorganic membrane including, as main component, metallic hydroxide, hydroxyapatite (Ca₁₀(PO₄)₅(OH)₂), for example, has two sites, one being a site of positive charge of calcium ion and the other being a site of negative charge of phosphoric acid base. Therefore, it is possible to separate a wide variety of solids having isoelectric point from acid to base. In general, a metallic hydroxide is alkaline or amphoteric. Therefore, the surface charge in water depends on the pH in the case of the inorganic membrane including, as main component, hydroxide.

In the case of the solid matter being metallic oxide, the surface charge of the solid matter depends on pH like the inorganic membrane. In the case of separation of the solid matter in the form of dispersed particles in a water solution, by the use of the inorganic membrane, the electric affinity between the inorganic membrane and the solid matter is decreased by adjusting the pH of the water solution to make the surface charge of the solid matter homopolar to the surface charge of inorganic membrane. By so doing, it is possible to reduce adhesion of the solid matter to the membrane surface, and achieve stable solid-liquid separation.

When, for example, the inorganic membrane is made of aluminum oxide and the solid matter is titanium oxide, the isoelectric point of the aluminum oxide lies in the vicinity of pH 9, and the isoelectric point of the titanium oxide lies in the vicinity of pH 6. Therefore, if the pH of the water solution is greater than 9, the aluminum oxide and titanium oxide in the water solution or aqueous solution are both charged negatively, so that the adhesion of the solid matter to the membrane surface becomes lower and consequently the solid-liquid separation can be performed stably.

Moreover, even in the case in which the pH of the water or aqueous solution is 7, if polyaluminum chloride is added as charge adjusting or controlling agent, to the water solution, the polyaluminum chloride is adhered to the surface of titanium oxide. Therefore, the surfaces of solid matter and inorganic membrane are both charged positively to homopolar charges, so that the adhesion of the solid matter to the membrane surface becomes lower and consequently the solid-liquid separation can be performed stably.

Furthermore, OSPW contains clay favorite which is mineral forming clay. For example, silicate mineral such as kaolinite (Al₂O₃.2SiO₂. 2H₂O) and montmorillonite is contained, and the surface is charged. Even such clay mineral can be separated from liquid by the use of the above-mentioned inorganic membrane.

Therefore, the solid matter which can be separated from liquid phase with the above-mentioned inorganic membrane is not limited to metallic oxide. The solid matter to be separated from liquid phase with the above-mentioned inorganic membrane may be minute particles containing metallic hydroxide and/or clay mineral other than metallic oxide. No limitation is imposed on the substance and components of the solid matter as long as a predetermined surface charge is exhibited in a water solution.

Moreover, for adjustment of pH, it is possible to add acid such as sulfuric acid, hydrochloric acid, nitric acid, or alkali such as sodium hydroxide, sodium carbonate, sodium hydrogen carbonate, as a solution prepared by dissolution and dilution.

As the charge adjusting agent, it is possible to employ chemical agent having charge heteropolar to the charge of particles dispersed in a liquid phase at a pH value. Examples of the charge adjusting agent are aluminum salt, iron salt, etc. Examples of organic charge adjusting agent are cationic polymer and anionic polymer. The charge adjusting agent may be an agent of single chemical substance or may be an agent including a plurality of chemical substances.

As the aluminum salt, there are low molecular weight type and high molecular weight or polymer type. Examples of the low molecular weight type aluminum salt are aluminum sulfate (Al₂(SO₄)₃), aluminum chloride (AlCl₃), ferruginous aluminum sulfate (Al₂(SO₄)₃+Fe₂(SO₄)₃), ammonium alum ((NH₄)₂SO₄.Al₂(SO₄)₃) and potassium alum (K₂SO₄.Al₂(SO₄)₃). Examples of the high molecular weight type aluminum salt are poly aluminum sulfate ([Al₂(OH)ₙ(SO₄)_{3-n/2}])ₘ) and poly aluminum chloride ([Al₂(OH)ₙCl₄₋ₙ]ₘ).

As the iron salt, too, there are low molecular weight type and high molecular weight type. Examples of the low molecular weight type iron salt are ferrous sulfate (FeSO₄.7H₂O), ferric sulfate (Fe₂(SO₄)₃), ferric chloride (FeCl₃), and copperas chloride (FeCl₃+Fe₂(SO₄)₃). Examples of the high molecular weight type iron salt are poly ferric sulfate ([Fe₂(OH)ₙ(SO₄)_{3-n/2}]ₘ) and poly ferric chloride ([Fe₂(OH)ₙCl₄₋ₙ]ₘ(SO₄)₃).

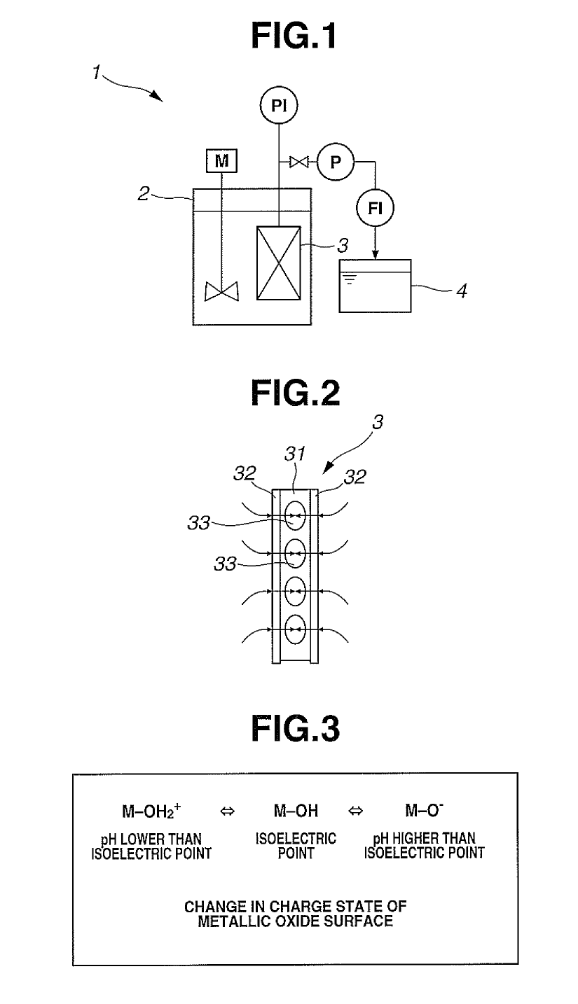

As the form of the membrane separation apparatus or system to which the present invention is applicable, one example is a membrane separation apparatus 1 as shown in FIG. 1, treating liquid containing solid matter in a batchwise manner, with the ceramic flat membrane 3 of the external pressure solid-liquid separation type as shown in FIG. 2, disposed upright so that the membrane surface is vertical, in a solid-liquid separation tank 2. The ceramic flat membrane or flat sheet membrane 3 is immersed in the liquid phase in the membrane separation tank 2. Under monitoring of a transmembrane pressure or differential pressure with a pressure gauge PI, by application of a negative pressure from the secondary side of ceramic flat membrane 3 with a suction pump

P, only filtrate water is sucked and filtered, and then transferred to a filtrate tank 4. Normally, a filtrate flow rate is controlled to a predetermined permeate flux under monitoring of a flow meter FI. The permeate flux (m/day) is a flow rate or quantity of flow per unit surface area of the membrane. The permeate flux is represented by a value obtained by dividing, by a membrane area, a net treated water quantity obtained by subtracting, from the quantity of sucked filtrate, a quantity of water used for back washing.

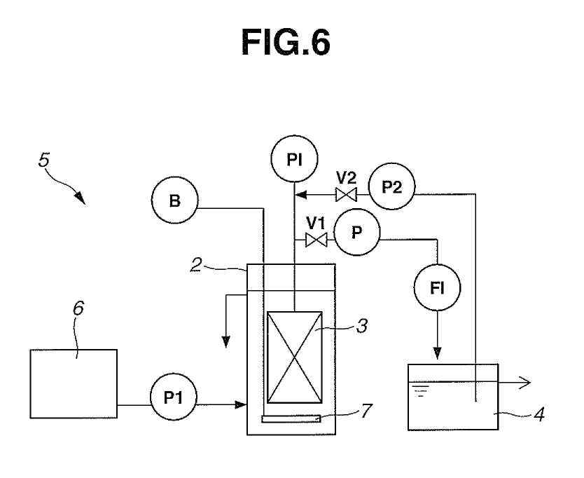

Another form of the membrane separation apparatus to which the present invention is applicable is a membrane separation apparatus capable of treating liquid containing solid matter continuously. For example, a membrane separation apparatus 5 shown in FIG. 6 includes a raw water supply pump P1 supplying water to be treated, to a membrane separation tank 2, a device to clean the membrane surface by aeration cleaning with air diffusion from below the ceramic flat membrane 3 to enable longtime continuous filtration, a device to clean the membrane with back pressure cleaning periodically by the use of filtered water, etc.

As explained above, it is possible to reduce adhesion or attachment of solid matter and formation of adherent layer to a membrane surface of an inorganic membrane, by setting a focus on the surface charges of the inorganic membrane and solid matter, and by adjusting or controlling the pH of a liquid phase in which the inorganic membrane and solid matter coexist, or adding, to the liquid phase, a chemical agent having a surface charge homopolar to the inorganic membrane. By so doing, it is possible to restrain fouling in the inorganic membrane and achieve stable filtration.

In dependence on the purpose and situation of the treatment for liquid containing solid matter, the present invention is applicable to a batchwise process and to a continuous process.

### PRACTICAL EXAMPLES

Practical examples of the present invention are explained below.

### Practical Example 1

The ceramic flat membrane 3 including aluminum oxide as metallic oxide was provided in the membrane separation tank 2 (volume 0.05 m³) of the membrane separation apparatus 1 shown in FIG. 1, and suspension liquid was introduced into this tank 2. The suspension liquid contained titanium oxide produced by hydrothermal synthesis, and the quantity of suspension liquid introduced into the tank was 2.5 L (the titanium oxide concentration 100 g/L).

As to other specification data of ceramic flat membrane 3, the nominal pore size was 0.1 μm, and the set of outside dimensions was W100×H250×T12 mm (effective membrane area 0.05 m²). The particle trapping efficiency was equal to or higher than 95% to 0.1 μm particles.

The above-mentioned suspension liquid was prepared to have an initial titanium oxide concentration of 5000 mg/L, and the pH of the suspension liquid was adjusted to a pH value of 10.5 by addition of sodium hydroxide. Suction pump P was connected with a suction port of the ceramic flat membrane 3, and was operated while the suspension liquid was agitated with an agitator or stirrer M. Thus, suction filtration was performed by operating suction pump P under monitoring of the flow meter FI, at a quantitatively controlled filtration flux of 0.3˜1.0 m/d. The filtration processed water was received in the filtration water tank or filtrate water tank 4. The transmembrane pressure was measured during filtration with the pressure gauge PI (Okano Seisakusho Co., Model DMP202N) disposed in the piping on the secondary side of ceramic flat membrane 3. An increasing speed or increasing rate of the transmembrane pressure was calculated from a difference between the transmembrane pressure at the start of filtration and the transmembrane pressure after 24 hours. The thus-calculated increasing speed of the transmembrane pressure difference was 0.01 kPa/day.

As the result of measurement of isoelectric point by taking a small amount of the titanium oxide suspension liquid used in this practical example, and using a ζ-potential & particle size measuring system (Otsuka Electronics Co., Ltd., Model ELSZ-1000ZS), the isoelectric point was 6.3. The ceramic flat membrane 3 used in this practical example was pulverized and the thus-obtained aluminum oxide was suspended in water. The isoelectric point of the thus obtained suspension liquid was measured with the above-mentioned ζ-potential particle size measuring system. As the result of the measurement, the isoelectric point was 9.2. In this practical example, the pH of suspension liquid in the membrane separation tank 2 is adjusted to pH 10.5. Therefore, the surface of titanium oxide in the suspension liquid is charged negatively because the titanium oxide is in the solution having the pH higher than the isoelectric point of 6.3.

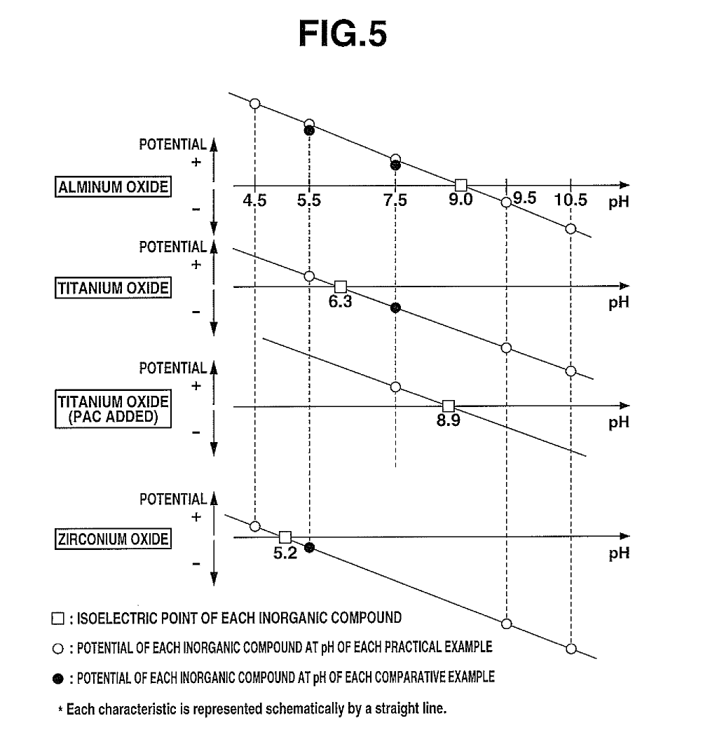

The material of the inorganic membrane in this practical example is aluminum oxide, which is in the suspension liquid having the pH (pH 10.5) higher than the isoelectric point 9.0, as shown in FIG. 5. Therefore, the surface of the inorganic membrane is charged negatively.

The titanium oxide particles (isoelectric point 6.3) in the suspension liquid are charged negatively to the homopolar side. Therefore, even if the titanium oxide particles are attached to the surface of the inorganic membrane during filtration, the electrostatic repulsion therebetween acts to decrease the compaction or consolidation. As a result, the increasing speed of the transmembrane pressure is made lower remarkably as compared to later-mentioned comparative examples 1 and 2, and the filtration becomes stable, as is evident from this practical example.

### Practical Example 2

In Practical Example 2, a filtration test was performed in the same manner as Practical Example 1, except that the pH of the suspension liquid was adjusted to 9.5. A measured value of the increasing speed or rate of the transmembrane pressure was 0.02 kPa/day. The condition of pH 9.5 of the suspension liquid is higher than the isoelectric point of aluminum oxide (9.0) and the isoelectric point of titanium oxide (6.3), as shown in FIG. 5. Therefore, the surfaces of both are charged negatively, and the electrostatic repulsion therebetween reduces the compaction or consolidation. As a result, the increasing speed of the transmembrane pressure is decreased remarkably as compared to the later-mentioned comparative examples 1 and 2, and stable filtering performance is attainable, as is evident from this practical example.

### Practical Example 3

In Practical Example 3, a filtration test was performed in the same manner as Practical Example 1, except that the pH of the suspension liquid was adjusted to 5.5. A measured value of the increasing speed of the transmembrane pressure was 0.02 kPa/day. The condition of pH 5.5 of the suspension liquid is lower than the isoelectric point of aluminum oxide (9.0) and the isoelectric point of titanium oxide (6.3), as shown in FIG. 5. Therefore, the surfaces of both are charged positively, and the electrostatic repulsion therebetween reduces the compaction or consolidation. As a result, the increasing speed of the transmembrane pressure is decreased remarkably as compared to the later-mentioned comparative examples 1 and 2, and stable filtering performance is attainable, as is evident from this practical example.

### Practical Example 4

In Practical Example 4, a filtration test was performed in the same manner as Practical Example 1, except that the pH of the suspension liquid was adjusted to 7.5, and moreover polyaluminum chloride (hereinafter referred to as PAC) was added as the charge adjusting or controlling agent, with an injecting ratio 50 mg/L, to the suspension liquid after the pH adjustment. A measured value of the increasing speed of the transmembrane pressure was 0.01 kPa/day. As the result of measurement of isoelectric point by taking a small amount of the suspension liquid after addition of PAC, and measuring the potential, the isoelectric point was 8.9. With addition of PAC, the titanium oxide surface is covered with PAC, and the isoelectric point becomes equal to 8.9. Therefore, the titanium oxide coated with PAC is charged positively at the condition of pH 7.5, as shown in FIG. 5. At the condition of pH 7.5, the inorganic membrane of material of aluminum oxide (isoelectric point 9.0) is also charged positively. Therefore, even if the titanium oxide particles coated with PAC in the suspension liquid are attached to the surface of the inorganic membrane of aluminum oxide during filtration, the electrostatic repulsion therebetween acts to decrease the compaction or adhesion. As a result, the increasing speed of the transmembrane pressure is decreased remarkably as compared to the later-mentioned comparative examples 1 and 2, and stable filtering performance is attainable, as is evident from this practical example.

### Practical Example 5

In Practical Example 5, a filtration test was performed in the same manner as Practical Example 1, by using zirconium oxide particles produced by precipitation reaction, in place of the titanium oxide used in Practical Example 1. As the result of the measurement of the isoelectric point of the suspension liquid of zirconium oxide particles (5000 mg/L) with the potential & particle size measuring system, the isoelectric point was 5.2. The pH of the suspension liquid was adjusted to 10.5, and the increasing speed of the transmembrane pressure was measured in the same manner as in Practical Example 1. As the result of the measurement, the increasing speed of the transmembrane pressure was 0.01 kPa/day. At the condition of pH 10.5 which is higher than the isoelectric point of aluminum oxide (9.0) and the isoelectric point of zirconium oxide (5.2), as shown in FIG. 5, the surfaces of both are charged negatively, and the electrostatic repulsion therebetween acts to decrease the compaction or adhesion. As a result, the increasing speed of the transmembrane pressure is decreased remarkably, as mentioned before, as compared to the later-mentioned comparative examples 1 and 2, and stable filtering performance is attainable, as is evident from this practical example.

### Practical Example 6

In Practical Example 6, the pH of the suspension liquid of zirconium oxide particles used in Practical Example 5 was adjusted to 9.5, a filtration test was performed in the same manner as Practical Example 5, and the increasing speed of the transmembrane pressure was measured. As the result, the increasing speed of the transmembrane pressure was 0.02 kPa/day. At the condition of pH 9.5 which is higher than the isoelectric point of aluminum oxide (9.0) and the isoelectric point of zirconium oxide (5.2), as shown in FIG. 5, the surfaces of both are charged negatively, and the electrostatic repulsion therebetween acts to decrease the compaction or adhesion. As a result, the increasing speed of the transmembrane pressure is decreased, as mentioned before, as compared to the later-mentioned comparative examples 1 and 2, and stable filtering performance is attainable, as is evident from this practical example.

### Practical Example 7

In Practical Example 7, a filtration test was performed in the same manner as Practical Example 5, except that the pH of the suspension liquid of zirconium oxide particles was adjusted to 4.5. As the result of measurement of the increasing speed of the transmembrane pressure, the increasing speed was 0.02 kPa/day. At the condition of pH 4.5 which is lower than the isoelectric point of aluminum oxide (9.0) and the isoelectric point of zirconium oxide (5.2), as shown in FIG. 5, the surfaces of both are charged positively, and the electrostatic repulsion therebetween acts to decrease the compaction or adhesion. As a result, the increasing speed of the transmembrane pressure is decreased, as mentioned before, and stable filtering performance is attainable, as is evident from this practical example.

### Practical Example 8

The membrane separation apparatus 5 in Practical Example 8 shown in FIG. 6 includes a raw water tank 6 (30 L), a raw water supply pump P1, a back washing pump P2, a blower B, and valves V1 and V2.

In the membrane separation tank 2 (dimensions W100 mm×H500 mm×D50 mm, effective volume 3 L), there is provided a diffuser pipe 7 in place of agitator M. The diffuser pipe 7 is a diffusing part for cleaning the membrane surface by aeration cleaning with air introduced from the blower B.

The raw water tank 6 is provided with an agitator or stirrer (not shown) for stirring the raw water in the tank uniformly. The raw water supply or feed pump P1 supplies the raw water from raw water tank 6 to membrane separation tank 2. The back washing pump P2 is a pump for performing back pressure cleaning periodically to clean the membrane with the filtered water in the filtered water or filtrate tank 4.

The valve V1 is a valve for securing a path to supply the filtered water to the filtered water tank 4 at the time of filtration and for shutting off a path to prevent return of the filtered water to the filtered water tank 4 at the time of cleaning. The valve V2 is a valve for securing a path to supply the filtered water to the ceramic flat membrane 3 in a direction opposite to the filtering direction at the time of the above-mentioned clearing.

In general, there are following methods for cleaning the inorganic membrane. (1) Aeration cleaning (a method of removing matter attached to a membrane surface of inorganic membrane with coarse bubbles and ascending water flow produced by blowing air from the lower side of the inorganic membrane), (2) Back pressure cleaning (a method of removing matter attached to a membrane surface of inorganic membrane by flow of treatment water in a direction opposite to the filtering direction), and (3) Inline cleaning (a method of dissolving or peeling off attached matter to recover an inorganic membrane from blockage and narrowing, by injecting chemical liquid such as sodium hypochlorite solution, into the inorganic membrane from the direction opposite to the filtering direction).

Practical Example 8 employed the cleaning methods (1) and (2) combined in a general filtering operation. As the diffuser pipe 7, this example employed a commercially available polyvinyl chloride pipe (inside diameter or caliber 13 mm) formed with several holes of a hole diameter of about 2 mm, to diffuse from below the ceramic flat membrane 3 by supplying coarse bubbles.

In the back pressure cleaning, the piping path is changed periodically, by operations of valves V1 and V2 between a path for filtration and a path for back washing, and the back washing pump P2 is operated whereas the suction pump P is stopped.

As the ceramic flat membrane 3, Practical Example 8 employed a ceramic membrane identical in specification to the ceramic flat membranes in Practical Examples 1-7. The isoelectric point of the ceramic flat membrane was 9.0.

To prepare raw water used in this practical example, actual drain water (OSPW) at an oil sands mining site in North America was obtained. Properties of the above-mentioned OSPW were: pH 7.29, potential −30.0 mV, particle size distribution (PSD) 0.7 μm, TSS (total suspended solids) 21.3 mg/L, TDS (total dissolved solids) 1920 mg/L, turbidity 26NTU, conductivity 3600 μS/m, TOC 41.3 mg/L, and oil content 2.1 mg/L.

The raw water in this practical example was prepared by adding, to the above-mentioned OSPW, aluminum sulfate (Al₂(SO₄)₃) as the charge adjusting agent, at an injecting ratio of 10 mg/L, to a suspension state, and the pH of the thus-obtained suspension liquid was adjusted to a target value of pH 10, with sodium hydroxide solution. The pH of this suspension liquid was 9.52, and the ζ potential was −27.5 mV.

The commercially available clay minerals, kaolinite and montmorilonite, were suspended in water and the isoelectric electric point of the suspension liquid was measured by the above-mentioned ζ potential & particle size measuring system. As the result of the measurement, the isoelectric point of kaolinite was 2˜4.6, and the isoelectric point of montmorilonite was 2˜3. Therefore, it is considered that, at the condition of the suspension liquid of pH 9.52, since the pH of the solution is higher than the isoelectric points of the clay minerals contained as main component, in the charged matter in the suspension liquid, the ζ potential became equal to the above-mentioned value, and the charge becomes negative.

On the other hand, the surface of the inorganic membrane of this practical example is charged negatively because the inorganic membrane is in the suspension liquid having the pH higher than the isoelectric point 9.0 of the inorganic membrane.

The suspension liquid prepared by stirring the liquid phase in raw water tank 6 with the agitator was supplied to the membrane separation tank 2 with the raw water supplying pump P1.

The suspension liquid in membrane separation tank 2 was filtered with the ceramic flat membrane 3 by operating the suction pump P at a preset value of 35.3 mL/min and a filtration flux of 1.08 m/day.

The preset value of raw water supplying pump P1 was set at a level at which a slight overflow was confirmed from an overflow pipe provided at a water level position in membrane separation tank 2, so as to avoid a difficulty in the filtering operation due to decrease in the quantity of water in the membrane separation tank 2 through long time operation.

The aeration cleaning was performed at all times by supplying air from blower B to diffuser pipe 7 at a flow rate set to 1.13 mL/min (0.03 times the filtering flow rate).

The back pressure cleaning was performed by operating the back washing pump P2 at a flow rate twice as large as the filtering flow rate, for 0.5 min in the state in which valve V1 was closed and valve V2 was opened, and thereby supplying the filtered water from the filtered water tank 4 to the ceramic flat membrane 3, at regular time intervals of a period of 10 min. After the back pressure cleaning, the destination of supply of the filtered water of ceramic flat membrane 3 was changed to the filtered water tank 4 by operating valves V1 and V2.

The transmembrane pressure was measured during filtration by the pressure gauge PI (Okano Seisakusho Co., Model DMP202N) disposed in the secondary side piping of ceramic flat membrane 3.

The variation with time of the transmembrane pressure from the time of start of filtration was recorded, and the increasing speed or rate of the transmembrane pressure was calculated. The calculated increasing speed or rate of the transmembrane pressure was 0.13 kPa/hour.

As evident from the value of potential of the suspension liquid, the surface charge of the solid matter formed by addition of the charge adjusting agent to the suspension liquid is electrically homopolar to the surface charge of the ceramic flat membrane 3. Therefore, the electrostatic repulsion therebetween acts to decrease the compaction or adhesion even if the solid matter is attached to the surface of ceramic flat membrane 3. As a result, the increasing speed or rate of the transmembrane pressure is decreased remarkably, as compared to the transmembrane pressure increasing speed in a later-mentioned comparative example 3, and stable filtering performance is attainable, as is evident from this practical example.

Moreover, in this practical example, by processing the surface of ceramic flat membrane 3 so that titanium oxide (isoelectric point pH 6.3), zirconium oxide (isoelectric point pH 5.2) or silica (isoelectric point near pH 4) is contained or applied as coating, it is possible to decrease the isoelectric point of the surface and to perform the solid-liquid separation to restrain the increasing speed of the transmembrane pressure even if the pH of the suspension liquid is adjusted a lower value.

### Comparative Example 1

In Comparative Example 1, a filtration test was performed in the same manner as Practical Example 1, except that the pH of the suspension liquid was adjusted to 7.5, and the increasing speed of the transmembrane pressure was measured. The measured value of the increasing speed of the transmembrane pressure was 3.5 kPa/day, and the progress of membrane clogging was very rapid. At the condition of pH 7.5, the surface of aluminum oxide (isoelectric point 9.0) is charged positively since the pH is lower than the isoelectric point, and on the other hand, the surface of titanium oxide (isoelectric point 6.3) is charged negatively since the pH is higher than the isoelectric point, as shown in FIG. 5. Therefore, the electrostatic attraction therebetween increases the degree of compaction of titanium oxide particles on the membrane surface. As a result, the increasing speed of the transmembrane pressure is increased, and membrane clogging proceeds rapidly, as is evident from this comparative example.

### Comparative Example 2

In Comparative Example 2, a filtration test was performed in the same manner as Practical Example 1, except that the pH of the suspension liquid in Practical Example 5 was adjusted to 5.5, and the increasing speed of the transmembrane pressure was measured. The measured value of the increasing speed of the transmembrane pressure was 3.2 kPa/day, and the progress of membrane clogging was very rapid. At the condition of pH 5.5, the surface of aluminum oxide (isoelectric point 9.0) is charged positively since the pH is lower than the isoelectric point, and on the other hand, the surface of zirconium oxide (isoelectric point 5.2) is charged negatively since the pH is higher than the isoelectric point, as shown in FIG. 5. Therefore, the electrostatic attraction therebetween increases the degree of compaction of titanium oxide particles on the membrane surface. As a result, the increasing speed of the transmembrane pressure is increased, and membrane clogging proceeds rapidly, as is evident from this comparative example.

### Comparative Example 3

In Comparative Example 3, following suspension liquid A and suspension liquid B were used. As the suspension liquid A, the above-mentioned OSPW was used directly. The suspension liquid B was prepared by adding the charge adjusting agent to the above-mentioned

OSPW as in Practical Example 8, but the pH adjustment was not performed.

Properties of the suspension liquid A were: pH 7.29, potential −30.0 mV, particle size distribution (PSD) 0.7 μm, TSS (total suspended solids) 21.3 mg/L, TDS (total dissolved solids) 1920 mg/L, turbidity 26 NTU, conductivity 3600 μS/m, TOC 41.3 mg/L, and oil content 2.1 mg/L. Properties of the suspension liquid B were: pH 7.15, potential −27.5 mV, and particle size distribution (PSD) 1.1 μm.

As the result of a filtration test performed in the same manner as Practical Example 8, with the suspension liquids A and B, the measured value of the increasing speed of the transmembrane pressure was 0.72 kPa/hour in the case of suspension liquid A, and 0.39 kPa/hour in the case of suspension liquid B.

The ceramic flat membrane 3 used in Comparative Example 3 includes aluminum oxide as main component, and the isoelectric point of this ceramic flat membrane 3 is 9.0. Accordingly, the surface of ceramic flat membrane 3 is charged positively under the pH conditions of suspension liquids A and B (suspension liquid A: pH 7.29, suspension liquid B: pH 7.15). Therefore, solid matter having a negatively charged surface in each suspension liquid receives electrostatic attraction, which functions to increase the degree of compaction of the solid matter including clay mineral as main component, on the membrane surface. For this reason, the increasing speed of the transmembrane pressure became higher. Therefore, the addition of charge adjusting agent having aggregation effect could slightly restrain the increasing speed of the transmembrane pressure by shifting the particle size distribution to increase the particle size. However, the effect of the charge adjusting agent was less than the result of the monopolarity between the surface charge of ceramic flat membrane 3 and the surface charge of the solid matter.

Thus, it is shown that the increasing speed of the transmembrane pressure cannot be restrained effectively merely by adding the charge adjusting agent and increasing the particle size of the solid matter while holding the surface charge of solid matter unchanged under the pH condition in which the surface charge of the inorganic membrane and the surface charge of solid matter are heteropolar to each other.

From the filtration tests of the above-mentioned practical examples and comparative examples, it is found that it is possible to filter a suspension liquid without membrane clogging by adjusting the pH of the suspension liquid to a value higher or lower than each of the isoelectric point of metallic oxide forming an inorganic membrane and the isoelectric point of particles in the suspension liquid. Consequently, it is possible to obtain filtered water which is clean and stable in quality, for reuse, and to concentrate suspended matter in the suspension liquid to a high concentration. The condensed liquid becomes a drain water. However, it is possible to decrease the quantity of the drain water and to achieve cost reduction of the filtration system.

Even when the pH of the suspension liquid lies between the isoelectric point of the metallic oxide forming the inorganic membrane and the isoelectric point of particles in the suspension liquid, it is found that it is possible to perform filtration of a suspension liquid in a manner to restrain membrane clogging by adding a charge adjusting or controlling agent covering the surface of the suspended matter and making the surface homopolar to the inorganic membrane.

Consequently, it is possible to obtain filtered water which is clean and stable in quality, for reuse, and to concentrate suspended matter in the suspension liquid to a high concentration. The condensed liquid becomes a drain water. However, it is possible to decrease the quantity of the drain water and to achieve cost reduction of the filtration system.

Moreover, it is found that, to separate solid matter contained in a liquid phase, even when the surface charge of the solid matter is electrically heteropolar to the surface of an inorganic membrane for separating the solid matter from the liquid phase, by adjusting the pH after adding a charge adjusting agent having a surface charge electrically heteropolar to the surface charge of the solid matter, to the liquid phase in a state to hold the surface charge of formed by the addition of the charge adjusting agent electrically homopolar to the surface charge of another solid matter formed by addition of the charge adjusting agent, it is possible to charge the surface of the inorganic membrane and the surface of the solid matter formed by addition of the charge adjusting agent so that the surface charge of the inorganic membrane is electrically homopolar to the surface charge of the solid matter formed by addition of the charge adjusting agent, and thereby to restrain the progress of membrane clogging during the filtration of the suspension liquid. Consequently, it is possible to obtain filtered water which is clean and stable in quality, for reuse, and to concentrate suspended matter in the suspension liquid to a high concentration. The condensed liquid becomes a drain water. However, it is possible to decrease the quantity of the drain water and to achieve cost reduction of the filtration system.

As the charge adjusting agent, polyaluminum chloride was used in some of the practical examples. However, similar effects as in the practical example can be achieved evidently by using the above-mentioned aluminum salt other than poly aluminum chloride, the above-mentioned iron salt and the above-mentioned cation or anion polymer.

1-8. (canceled)

9. A solid-liquid separating method for solid-liquid separation of solid matter contained in a liquid phase with an inorganic membrane, the solid-liquid separating method comprising:
a step of measuring isoelectric points of the solid matter and the inorganic membrane in advance; and
a step of adjusting a pH of the liquid phase in accordance with the isoelectric points at a time of the solid-liquid separation,
in the step of adjusting the pH, the pH of the liquid phase being adjusted to a lower pH value lower than the isoelectric point of the solid matter and the isoelectric point of the inorganic membrane or a higher pH value higher than the isoelectric point of the solid matter and the isoelectric point of the inorganic membrane.

10. The solid-liquid separating method as recited in claim 9, wherein the solid matter is formed by adding a charge adjusting agent, and the charge adjusting agent has a surface charge electrically heteropolar to a surface charge of the solid matter contained in the liquid phase before addition of the charge adjusting agent.

11. The solid-liquid separating method as recited in claim 10, wherein the solid matter formed by addition of the charge adjusting agent has a surface charge electrically homopolar to a surface charge of another solid matter formed by addition of the charge adjusting agent.

12. The solid-liquid separating method as recited in claim 9, wherein the solid matter is one of metallic oxide, metallic hydroxide and clay mineral.

13. The solid-liquid separating method as recited in claim 10, wherein the charge adjusting agent is one of aluminum salt, iron salt, and cationic or anionic polymer.

14. The solid-liquid separating method as recited in claim 9, wherein the inorganic membrane includes, as main component, at least one of metallic oxide and metallic hydroxide.
